(19) United States
(12) Patent Application Publication
(10) Pub. No.: US 2013/0234860 A1
(43) Pub. Date: Sep. 12, 2013

(54) PIPELINE SYSTEM AND METHOD FOR OPERATING A PIPELINE SYSTEM

(71) Applicants: Rudolf Sollacher, Eching (DE); Thomas Wuchenauer, Bernstadt (DE)

(72) Inventors: Rudolf Sollacher, Eching (DE); Thomas Wuchenauer, Bernstadt (DE)

(73) Assignee: Siemens Aktiengesellschaft, Munchen (DE)

(21) Appl. No.: 13/988,835

(22) PCT Filed: Oct. 31, 2011
(86) PCT No.: PCT/EP11/69129

§ 371 Date: May 22, 2013

(30) Foreign Application Priority Data
Nov. 30, 2010 (DE) 102010062191.9

(51) Int. Cl. G01V 3/18

(52) U.S. Cl. CPC G01V 3/18
USPC 340/854.5

(57) ABSTRACT

A pipeline system includes at least one electrically-conducting pipeline, which is connected to the ground and which is isolated from the ground. A cathode protection system is provided, which includes a plurality of ground rods arranged in the ground, which are each connected electrically to the ground and are coupled electrically to the pipeline. The pipeline system also includes a communication system with a plurality of communication devices, allowing data to be transmitted via the pipeline for communication between the communication devices. The communication devices have sensor units arranged along the pipeline, which are supplied with energy from the cathode protection system.

### CROSS REFERENCE TO RELATED APPLICATIONS

This application is the US National Stage of International Application No. PCT/EP2011/069129 filed Oct. 31, 2011 and claims benefit thereof, the entire content of which is hereby incorporated herein by reference. The International Application claims priority to the German application No. 102010062191.9 DE filed Nov. 30, 2010, the entire contents of which is hereby incorporated herein by reference.

### FIELD OF INVENTION

The invention relates to a pipeline system and to a method for operating such a pipeline system. The pipeline system comprises at least one electrically-conductive pipeline which is connected to the ground and which is insulated from the ground. The pipeline system further comprises a Cathode Protection System (CPS), comprising a number of grounding rods arranged in the ground which are each electrically connected to the ground and are electrically coupled to the pipeline, finally the pipeline system includes a communication system with a number of communication devices, wherein data is able to be transmitted over the pipeline for communication between the communication devices.

### BACKGROUND OF INVENTION

Pipelines for transporting gases and liquids over a long distance are usually buried in the ground. The greatest danger of damage to the pipeline comes from building works, theft, earthquakes and landslips. Building work in which the soil is excavated has proved to be the greatest danger, so that a lack of knowledge of the presence of the pipeline could lead to said pipeline being damaged. The operators of the pipelines attempt to counter this danger with corresponding monitoring measures. Depending on the technical design of the monitoring measure, not only is the pipeline itself monitored in such cases but also an adjacent area of the pipeline.

The difficulty in monitoring a pipeline lies on the one hand in having to distinguish between potentially dangerous events and other non-critical events. In addition there is the desire for the monitoring facility not to be externally visible to a user, in order to avoid theft of the components of the monitoring facility.

A pipeline can extend over several hundred or several thousand kilometers. Typically there are pumping stations provided at distances of around 150 km and valve stations at distances of around 25 to 30 km. Both the pumping stations and also the valve stations are connected to a communication network, via which data relating to the monitoring is transmitted to a control center.

Various versions of monitoring facilities are known, for example microphones can be used for this purpose, the output signals of which are examined for critical event patterns. As an alternative there can be video monitoring of the pipeline using visible light or infrared radiation. The disadvantage is that the microphones and video cameras must be disposed above ground level. For this reason however there is the danger of these being damaged by vandalism or stolen. In addition the monitoring components require an external power supply which can be provided either in the shape of batteries or accumulators or solar cells. Batteries or accumulators must however be replaced at regular intervals, which makes maintenance of the monitoring facility expensive. The provision of a wired power supply, for example in parallel to the pipeline, is only to be undertaken cost effectively when the pipeline is being laid. Retroactive excavation of the ground for a separate power supply of the monitoring units is not economically worthwhile.

One of the advantages of using monitoring units arranged above ground is that communication with the central monitoring unit of the monitoring facility can be realized in a simple manner by wireless communication techniques. The use of hardwired communication technologies is associated with high costs, especially with retroactive installation of a monitoring facility.

The use of seismic sensors, which are disposed close to the pipeline in the soil, has the advantage that the respective monitoring units are not visible externally and are thus better protected against vandalism and theft. However arranging the energy supply and communication with the central monitoring unit becomes more difficult, where there is not to be any recourse to components visible externally (e.g. solar cells or antennas). A wired power supply and also communication with the central monitoring device on the other hand again requires that the corresponding lines are laid in the ground.

Monitoring of the pipeline is likewise possible using a glass fiber line, which is sunk in the ground along the pipeline. Light pulses are injected into the glass fiber, which are reflected in the latter. In the event of a deformation because of an external effect, a changed, detectable reflection pattern is produced, which can be localized on the basis of the reflection pattern. A disadvantage of this method of operation lies in the fact that a retroactive installation requires complete excavation of the ground along the pipeline and is therefore associated with high costs.

The use of satellite images to monitor a pipeline is also known. However it is difficult to fully monitor the entire line length of the pipeline. A further disadvantage lies in the higher operating costs.

A pipeline communication system is known from U.S. Pat. No. 6,498,568 B1 in which there is communication between communication nodes arranged along the pipeline via the pipeline itself. The electrically conducting pipeline which is insulated from the ground is used as a communication conductor. In such cases the transmission signals are overlaid onto a cathode protection system. FFSK (Fast Frequency Shift Keying) is used as a modulation scheme.

### SUMMARY OF INVENTION

The object of the present invention is to specify a pipeline system which allows autonomous operation of the sensor units arranged along the pipeline and which is able to be manufactured with less effort and at lower cost than the solutions known in the prior art.

These objects are achieved by the features of the independent claim(s). Advantageous embodiments emerge from the dependent claims.

The invention creates a pipeline system comprising the following: At least one electrically-conducting pipeline which is connected to the ground and which is isolated from the ground; a cathode protection system having a number of grounding rods arranged in the ground, which are each electrically connected to the ground and are electrically coupled to the pipeline; a communication system with a number of communication devices, wherein data is able to be transmitted via the pipeline for communication between the communication devices. The pipeline system is characterized in such cases in that the communication devices include sensor units arranged along the pipeline, which are supplied with energy from the cathode protection system.

The inventive method for operating a pipeline system of the aforementioned type is characterized in that events occurring in the vicinity are detected by the communication devices arranged along the pipeline and embodied as sensor units, wherein the sensor units are supplied with energy from the cathode protection system.

An advantage of the inventive pipeline system lies in the fact that no separate energy supply is required for the communication device. This means that no batteries or accumulators needing to be replaced at regular intervals are necessary for the operation of the communication device. This helps to cut down on costs. Likewise the use of solar cells and the like, which would have to be arranged above ground, and are thus exposed to the danger of damage or theft, can be dispensed with.

The pipeline can rest on the ground. In particular the pipeline is buried in the ground or is arranged in a hole or tunnel bored in the soil.

The data is transmitted via the pipeline itself, i.e. in its material. As an alternative it could be transmitted via the cathode protection system or via the medium transported in the pipeline.

In one embodiment the sensor units are seismic sensor units for detecting ground tremors. Such sensor units can especially be used if the pipeline is disposed under the surface of the ground e.g. is buried in the ground. Since a cathode protection system is typically provided ex-works for pipelines buried in the ground, the inventive pipeline system can be provided at low cost.

After the initial burial of the communication device embodied as seismic sensor units—apart from in the event of a defect—no further access to these units is necessary. The fact that the communication device communicates by the pipeline means that there is no need for the provision of separate communication lines between the communication devices. Likewise no antennas attached above ground need to be provided for wireless communication. This means that it is possible to monitor the pipeline with just few additional components.

It is also worthwhile for the communication devices too to be supplied with energy from the cathode protection system.

In an expedient embodiment an energy supply unit of a respective sensor unit is connected electrically between an assigned ground rod of the cathode protection system and the pipeline, especially a bracket of the cathode protection system surrounding the pipeline, wherein energy is able to be obtained by the energy supply unit for supplying the sensor unit from a voltage difference between the ground rod and the pipeline or the bracket. It goes without saying that the bracket of the cathode protection system surrounding the pipeline is electrically connected to the pipeline. Likewise it is known to a person skilled in the art that each ground rod is assigned a bracket. In accordance with this embodiment there is provision, at each point of the pipeline at which a sensor unit is to be provided, to also provide a ground rod. Since only the voltage difference and the line current between ground rod and pipeline are of significance for obtaining energy, it is also not necessary for the sensor units to have a shared reference potential.

In a further advantageous embodiment the energy supply unit comprises an energy store, such as the storage capacitor for example, for temporary provision of energy to the sensor unit, especially during the transmission of a message to another communication device, wherein the energy store is able to be charged from the cathode protection system. An advantage of this embodiment lies in the fact that on the one hand during phases during which the sensor unit needs more energy than is able to be withdrawn from the cathode protection system, the missing energy can be taken from the energy store. On the other hand the energy store can be recharged again during phases in which the sensor unit needs less energy than can be provided by the cathode protection system. A storage capacitor or a Super Cap can be used as an energy store for example. The supply of energy to the sensor unit can thus be provided without additional batteries or accumulators.

In a further advantageous embodiment a respective sensor unit comprises a processor unit for processing signals resulting from a ground tremor in which characteristic vectors are determined from the signal and are classified on the basis of a comparison with reference data stored in the sensor unit, wherein, for classification as a critical event, an alarm message is sent by the sensor unit. The alarm message is preferably sent only if a minimal probability for a critical event exists. The fact that the sensor unit undertakes the processing of the signals accepted by it autonomously means that only a few messages need to be transmitted to a central processing unit. As a result, this enables the sensor unit to be operated with a lower energy demand, by comparison with a sensor unit which transfers all data detected by it to the central processing unit for subsequent evaluation. The preprocessing of the detected signals and the transmission of only relevant messages ensures that energy consumption is low, which allows the energy supply to be realized with the cathode protection system.

In a further embodiment the processing unit is embodied to sample the signal of the sensor unit at a sampling rate of 100 Hz. A seismic sensor unit generates a time-dependent voltage signal which depends on the acceleration through a seismic wave. Since only low frequencies below 10 Hz are of relevance for monitoring the pipeline, a sampling rate of 100 Hz is sufficient to be able to detect relevant events.

It is further expedient if, for determination of the characteristic vectors by the processing unit, a Fourier transformation is able to be applied to at least one sample vector of the sampled signal with a given number of samples per sample window, especially with different sample window sizes. The use of a Fourier transformation allows a subsequent reduction of the measurement data, so that the evaluation of the measurement data can be carried out by a conventional microprocessor. This means that it is possible to keep the energy consumption of the sensor unit low. In that the method refers back to a number of (equal size) sample vectors from sample windows of different sizes, relevant events can be detected by the seismic sensor unit with a high accuracy.

In a further embodiment a wavelet transformation is able to be applied to the sampled signal for determination of the characteristic vectors by the processing unit. The wavelet transformation can advantageously be employed since seismic signals are often of a spasmodic nature.

The resulting, normalized Fourier or wavelet coefficients are able to be compared by the processing unit with the reference coefficients stored in the sensor unit. The reference coefficients can initially be stored in a respective sensor unit. It is likewise possible, because of the option of being able to communicate with the sensor units, to feed new or updated reference data into the sensor units even during ongoing operation.

In order to obtain high detection accuracy of the sensor units it is further expedient for a sensor of the sensor unit to be embodied to detect frequencies of a maximum of 10 Hz. The sensors of the sensor unit can for example be embodied as geophones, which comprise a differential induction sensor.

It is further advantageous for a sensor unit to comprise a number of sensors, preferably arranged spatially separated, of which the signals are able to be supplied to a common processing unit of the sensor unit. This makes it possible to distinguish between relevant ground tremors and other “noise events”, such as a train passing in the vicinity of the pipeline for example, and a higher detection accuracy can be obtained as a result. In practice it has proved to be expedient for a processing unit to be connected to three spatially-separated sensors.

In a further expedient embodiment the sensor units are arranged at predetermined distances between two access nodes of the communication system, wherein a message transferred by a sensor unit to one of the access nodes is transmitted via the intervening sensor units, wherein the message is forwarded by at least some of the intervening sensor units. Forwarding is to be understood as resending the message in this case to ensure that it is readable by the next recipient, the access node or a further intervening sensor unit. Communication in the communication system can be based for example on a tree routing protocol.

The access nodes are preferably arranged in the pumping and/or valve stations of the pipeline and are supplied with energy by an energy supply of the pumping and/or valve station. The respective access nodes for their part are coupled to a central control entity which evaluates or visualizes the (alarm) messages arriving at it.

In a further embodiment the communication devices each comprise a transceiver unit which is embodied for using pulse width or pulse location modulation or also FSK (Frequency Shift Keying) for communication, especially CSMA-CA (Carrier Sense Multiple Access with Collision Avoidance) or TDMA (Time Division Multiple Access) or Low Power Listening. The use of CSMA-CA has the advantage of short latency times with low data traffic. By contrast TDMA is deterministic, but however by contrast with CSMA-CA exhibits a higher latency. All three said methods offer the advantage of making a communication with low energy requirement possible, through which energy supply from the cathode protection system is made possible.

### BRIEF DESCRIPTION OF THE DRAWINGS

The invention is explained in greater detail below on the basis of exemplary embodiments. The figures are as follows:

FIG. 1 shows a schematic diagram of an inventive pipeline system,

FIG. 2 shows a schematic block diagram of an inventive sensor unit which is supplied with energy from a cathode protection system of the pipeline,

FIG. 3 shows a schematic diagram of a sensor of the inventive sensor unit, and

FIG. 4 shows a block diagram which illustrates the energy supply of the inventive sensor unit.

### DETAILED DESCRIPTION OF INVENTION

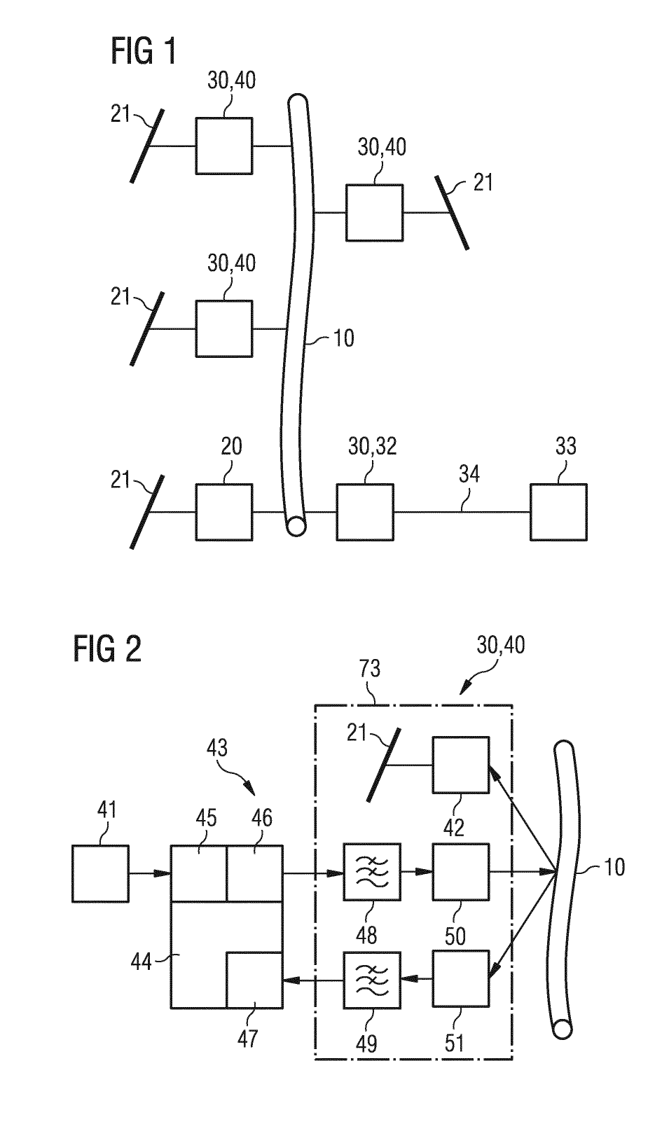

FIG. 1 shows an inventive pipeline system in a schematic diagram. Reference character 10 designates a section of a pipeline 10. The pipeline consists of an electrically-conducting material and is buried in the ground and isolated from the latter. Communication devices 30 are arranged along the pipeline 10 at predetermined distances. The communication devices 30 labeled with the reference character 40 represent sensor units. An access point is designated with reference character 32, which is disposed for example in a pumping or valve station (not shown in the schematic diagram). The access point 32 is connected via a Wide Area Network (WAN) 34 to a central processing unit 33 (also called a Control Center). The central processing unit 33, the access point 32, like all other access points of the pipeline too, as well as the sensor units 40, are part of a communication system and can exchange messages with one another.

Reference characters 20, 21 represent the cathode protection system, known in principle to the person skilled in the art, which is electrically connected to the pipeline 10. The unit 20 is a power source which feeds power into the electrically-conducting pipeline 10, which flows away via ground rods 21. One ground rod 21 is connected to a sensor unit 40 in each case. The cathode protection system further comprises brackets not shown in FIG. 1, which are assigned to a respective ground rod 21 and contact the pipeline 10 electrically-conductively. The ground rods 21, which consist of stainless steel and have a length of around one meter, are buried in the ground. The sensor units 40 can be supplied with energy from a voltage difference existing between the pipeline 10 and the ground rods 21. A sensor unit 40 communicates—if necessary, via one or more other sensor units 40—with an access point 32 of the communication system via the pipeline 10.

The signal and information processing is described below:

Each of the sensor units 40 comprises at least one seismic sensor 41, especially a geophone. By means of the seismic sensors critical events for the pipeline, such as building work for example, can be detected, since this creates seismic waves. A critical event is to be understood as events which could potentially damage the pipeline. An analysis of the data recorded by the seismic sensors is undertaken in a respective sensor unit itself.

The most relevant types of seismic waves are so-called Rayleigh waves which have the lowest attenuation. The sensor units are buried at a depth of up to approximately 1.5 m. Because of this fact nears surface waves contribute to the greatest proportion of activation of the sensors. These types of waves decay exponentially as the distance from their source increases. The inverse characteristic decay length is a linear function of the wavelength and thus of the frequency of the wave. Typical values are of the order of magnitude of 1/500 m/Hz. With a 100 Hz wave this leads to an attenuation of around 1 dB/m, while the attenuation for a 10 Hz wave amounts to approximately 0.1 dB/m. If a sensor of a sensor unit 40 is to monitor an area of 500 m, waves which are created by a seismic source can be attenuated up to 500 dB for a 100 Hz wave or 50 dB for a 10 Hz wave. For this reason it is sufficient for the sensor of the sensor unit 40 to be embodied to detect frequencies of maximum 10 Hz.

A seismic sensor generally creates a time-dependent voltage signal as a function of an acceleration generated by the seismic waves. Since only low frequencies of less than 10 Hz are of significance for monitoring the pipeline, a sampling rate of 100 Hz is sufficient. After each sampling interval an amplifier of the sensor unit is activated which provides an amplified voltage signal. This can be stored in a register with low energy consumption. At regular intervals of roughly every minute a microcontroller or a DSP (Digital Signal Processor) reads out the stored signal sequence and extracts the power spectrum or characteristic vectors which are stored in another register. The characteristic vectors are compared with characteristic vectors which are representative of different typical events of seismic waves. If a sufficient similarity with a critical event can be established, an alarm signal is sent out by the sensor unit concerned and transmitted to the access point 32.

Suitable characteristic vectors and their classification can be determined off-line using machine learning methods. The detection and classification capability can be improved by “online” learning methods based on false alarms and new events. The latter requires that the characteristic vectors are transmitted to the central processing unit 33 and are supplemented there by information about the type and the seriousness of the event. In such cases it is likewise possible to generate information about the probability of an event, which can be processed as useful information for decision-making by the central processing unit.

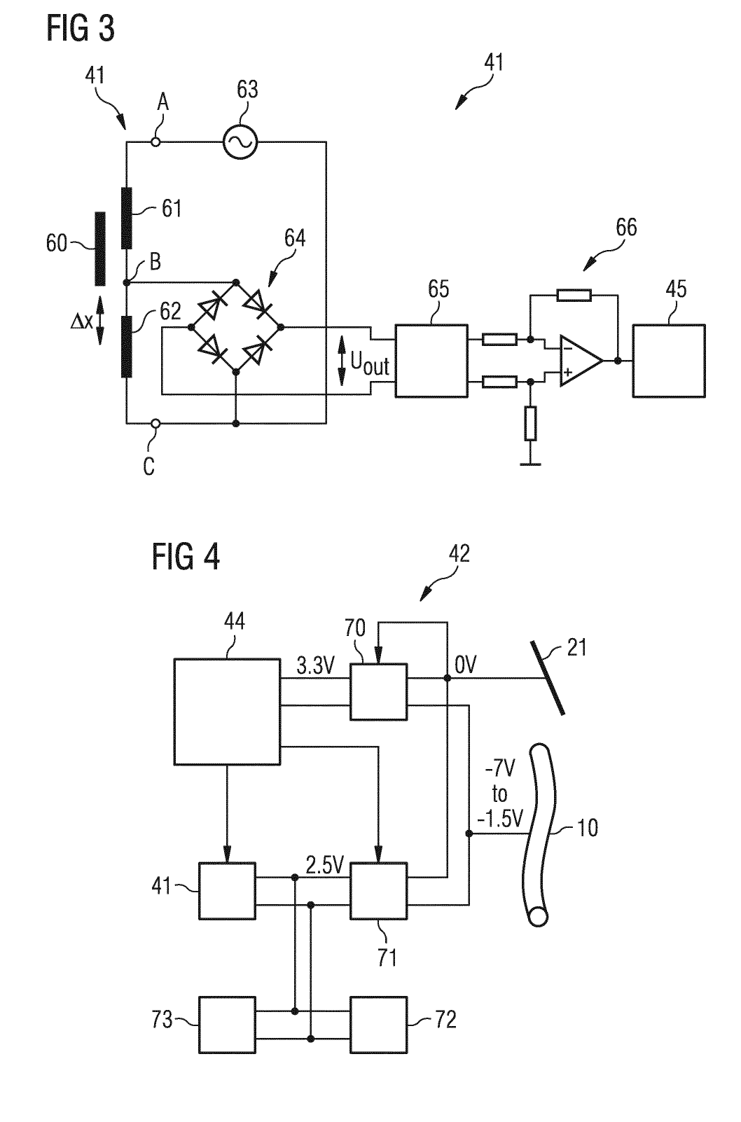

FIG. 2 shows a schematic block diagram of a sensor unit 40 used in an inventive pipeline system. The number 41 designates the sensor already mentioned, especially a geophone, which will be explained in more detail later in conjunction with FIG. 3. The sensor 41 comprises an energy supply unit 42, which is disposed electrically between the ground rod 21 and the pipeline 10 as well is a processing unit 43. The processing unit 43 receives the signals generated by the sensor 41 at an analog-digital converter 45. This applies the digitized signals to a signal processor 44. In the event of a critical event having been detected as part of signal processing, a message representing an alarm signal will be supplied to a digital-analog converter 46. On its output side this is connected to a reconstruction lowpass filter 48. The lowpass filter 48 is connected via an amplifier 50 to the pipeline 10 via which the message will be transmitted. Also connected to the pipeline 10 in the receive path is a low-noise amplifier 51, which is connected on its output side to an anti-aliasing lowpass filter 49. This in its turn is connected to an analog-digital converter 47, which makes the digitized receive signals available to the signal processor 44.

All messages transmitted via the pipeline are received by a respective sensor unit via the receive path of the sensor unit 40. If the message is addressed to the receiving sensor unit 40, said message is processed by the signal processor 44. The processing can for example comprise retransmission of the received message via the transmit path, in order to ensure a safe transmission to the access point 32 even over a long distance.

To be able to ensure an energy supply of the sensor unit 40 solely from the cathode protection system and also to be able to dispense with additional energy stores such as batteries, accumulators or solar cells, the use of energy-efficient components and also energy-efficient operation of the components is necessary. Many seismic sensors available on the market are already equipped with additional electronics which barely leave any space available for such energy optimization. A sensor suitable for the invention is for example the model B12/200 made by HBM Mess- and Systemtechnik GmbH. This is a differential, induction-based sensor which is shown schematically in conjunction with its circuitry in FIG. 3.

The sensor consists of a core 60 and two coils 61, 62 connected in series with one another. Terminals of the coils are designated A, B and C. The sensor 41 is driven by an oscillating voltage at the terminals A, C. An oscillator 63 is connected to the terminals A, C for this purpose. The resulting oscillating voltage at the terminals B and C depends on the position of the core 60, wherein the position is dependent on a ground tremor. The core is part of a “mass string” system which is deflected by a distance x by a force acting on it or an equivalent acceleration, caused by a seismic wave.

The seismic sensor B12/200 has a resistance of 40Ω and an inductance of 10 mH between the terminals A and C. With an oscillating supply voltage of nominally 2.5 V (peak-to-peak) and a frequency of 5 kHz, the sensor needs the power of around 2.5 mW. With a supply voltage of 2.5 V the sensor produces an output signal of around 10 mV/g, wherein g represents the ground acceleration. Typical geophones reach a sensitivity of 0.1 mg. This signal strength results in an output signal of around 1 μV. For this reason the output signal, after a rectification by the rectifier 64 and a filtering by the filter 65, is amplified by means of an amplifier 66.

The time for sampling a sensor value can amount to around 30 μs if for example a microprocessor of type MSP430 from Texas Instruments and its analog-digital converter are used. With a sampling frequency of 100 Hz the duty cycle of sensor, oscillator and amplifier amounts to 3‰. With the power consumption of 5 to 10 mW in the active state an approximate consumption of 15 to 30 μW is produced.

The oscillation signal can be generated with a discrete silicon oscillator (e.g. LTC6900) with a power consumption of 500 μW, wherein a passive bandpass filter is connected downstream from the oscillator.

As already explained, the signal processing to determine whether a critical event is present is undertaken entirely in the respective sensor unit 40. The signal processing comprises pre-processing and also detection and classification.

The purpose of pre-processing is to extract characteristic vectors for detection and classification. One option for determining the characteristic vectors consists in applying a (discrete) Fourier transformation to a sample vector of length N. A Fast Fourier-Transformation (FFT) requires O(N log 2(N)) operations and O(N) memory space.

The output of the seismic sensor 41 is usually sampled at a rate of 100 Hz. With a sampling window of approximately 10 s, N=1024 samples are obtained, which require a few Kbytes of storage and around 40000 computing operations. If the MSP430 microprocessor is used this can be carried out within 2.5 s. The power consumption in the active state amounts to around 10 mW. Increasing the sample window to 100 s would thus result in around N=10000 samples (i.e. a few 10 Kbytes of storage and around 33 s execution time). This would impose excessive demands on the storage capacity of the said processor.

There is therefore provision for applying an FFT to a few sample windows of different size, but with the same number of samples M, simultaneously. The FFT reduces the memory requirement by comparison with the above exemplary embodiment by the factor 7 M/(1024*(log 2M−3)) for a maximum window size of approximately 10 s. The execution time is reduced by the factor 127 M*log 2M/(10240*(M/8−1)). It has proven to be expedient to select a value of M=32, which results in a reduction in memory requirement by the factor 7/64=0.11 and in a reduction in computing time by the factor 127/192=0.66. This enables a Fourier transformation to be undertaken at the microcontroller, such as the said MSP430, wherein no additional DSP is necessary. It is assumed for the power consumption that the microcontroller is continually active since other tasks also run on the latter.

As an alternative a fast wavelet transformation can be applied for extracting the characteristic vectors. This is especially useful for seismic signals with a burst character.

The resulting vector of Fourier (or wavelet-) coefficients or their absolute values can be further compressed by forming an average value of the absolute values or squared amounts of the coefficients within suitable frequency bins (frequency lines).

In environments with a plurality of seismic sources, for example caused by traffic (trains etc.) which occurs in the vicinity of the pipeline, the signal detected by a sensor consists of different mixed signals. To enable the sources of signals to be separated different sensor signals are needed. In principle these signals can be detected and taken into consideration by adjacent sensor units, which would however be conditional on communication between the adjacent sensor units. There can therefore be provision for a sensor unit to have a plurality, especially three, sensors at a distance of around 5 to 10 m from one another, which are coupled to the same processing unit 43. A sensor unit with a number of sensors can be operated with less energy than communication between a number of sensor units would cause.

The signal sources can be separated by a Principal Component Analysis (PCA). A normalized eigen vector of a 3×3 correlation matrix of the three sensor sample vectors must be determined for this purpose. The sample vectors are projected onto the three eigen vectors. These represent the “separated” signals which are processed as described above. The effort for sampling and pre-processing trebles. In addition the eigen vectors of the symmetrical 3×3 matrix must be determined This requires less than 10 ms on the MSP430 microcontroller.

An analysis of the relative strengths of the Fourier coefficients is also carried out as part of the detection and classification. For this purpose the vectors of the Fourier coefficients are normalized to their total power. These normalized characteristic vectors are compared with the characteristic vectors stored locally in the sensor units, wherein these reference characteristic vectors represent typical events and labels associated therewith. For example a reference characteristic vector represents an event ID and a measure of the relevance or seriousness of the event. The reference characteristic vectors can be stored in a database of the sensor unit. The database should likewise contain “normal” events which are not critical.

The detection and classification is carried out simultaneously. A distance of each characteristic vector is compared by the processing unit with all representative reference characteristic vectors of the database. The reference characteristic vectors with the smallest distance then represent the present detected event. The distance measurement can be used to assign probabilities for different events. The complexity of the comparison of a measured characteristic vector of size N with all M database entries is O(NM). For N=1000 and M=10 this requires approximately 0.63 s on a MSP430 microcontroller. The required storage capacity for a multiscalar Fourier decomposition with 138 samples at each time amounts to 267 bytes with two bytes per value and without down sampling.

An alarm message is only transmitted when the detected event is a critical event with a specific minimum probability.

The database can be initially created by measurements, through which as many typical events as possible should be accepted into the database. In addition it is sensible for a database to be further trained. New relevant events can be included by an updating of the database. For example this enables differences in the propagation of a seismic wave as a result of different earth or ground characteristics to be taken into account. New event vectors can initially be stored locally, for example in the central processing unit. These can be distributed to the sensor units at night for example when no building work is taking place.

As explained, the messages are transmitted via the pipeline from a communication device 30 of the pipeline system to another communication device. The network layer is thus provided by the pipeline, i.e. by its material.

In such cases the following different types of messages are transmitted:

1. Control Messages:

The sensor units together with the access points and the central processing unit form a communication network. The sensor units must establish routes to the access points which are located in the valve and/or pumping stations. Control messages (Control Data Packets) are generated by the access points and contain an identifier of the access point, the identifier of the last forwarding access point and the hop distance to the access point. For reasons of redundancy both access points at the opposite ends of a pipeline section should establish a network.

Each sensor unit administers a list of neighbors from which it can receive messages and a quality indicator for direct connection to each of these neighbors. A communication device forwards control data by a broadcast if the connection from the receiver has an acceptable quality. Messages already received are ignored in order to avoid loops. Based on the hop distance to an access point and the quality of the connection, different adjacent sensors can be selected as forwarding access points for messages which are intended for a specific access point. Control messages can also contain time stamps which are needed for time synchronization of the communication device. Together the size of the packets amounts to around 17 bytes, including a separator symbol (4 bytes), an identifier of the access point (2 bytes), an identifier of the last forwarding communication device (2 bytes), the hop distance (1 byte) and a time stamp (8 bytes). These control messages can be transmitted at intervals of around 30 minutes.

2. Alarm Messages:

As soon as a critical event has been detected and classified by a sensor unit, a corresponding alarm message is generated and is transmitted to the two adjacent sensor units, which also forward the alarm message to the further access points lying in their direction. If one of the two connections has an error, an alternative adjacent communication device is selected as the forwarding access point. Alarm messages include the identifier of the sensor node creating the alarm message, the time that the critical event occurred, its classification and, optionally, a degree of probability for the classification. Since the location of a sensor unit sending out the alarm message is known, after the alarm message is received, the sensor unit can determine the precise location on the basis of a knowledge of the identifier. The size of such an alarm message amounts to 16 bytes, including separator symbols (4 bytes), the identifier of the sending sensor unit (2 bytes), the classification (1 byte), the probability (1 byte) and a time stamp (8 bytes).

3. Configuration Messages:

The sensor units are embodied such that these units can be reconfigured. This can be necessary for example in the event of updating of the reference characteristic vectors. The reconfiguration can be undertaken by a “flood” mechanism, similar to the network control message, wherein neighboring communication devices forward the messages. Configuration messages include the identifier as well as the configuration type and the configuration data. The identifier of the receiver can be replaced by a broadcast address. Messages are transmitted rarely, for example once a month or once a year. Larger amounts of configuration data, for example for updating the database of the characteristic vectors, can be provided in subunits of a smaller size.

4. Data Upload Messages:

For an update of the database with the reference characteristic vectors, characteristic vectors locally in a read-only memory (for example an EEPROM) of the sensor unit stored must be transmitted to the central processing unit 33. The communication mechanism in this case is the same as for the alarm messages. However the priority is lower here. These messages comprise historic information and contain the identifiers of the sending sensor unit and a sequence of characteristic vectors and associated time stamps. This type of message transmission is restricted to times with less (seismic) activity, for example during the night, at which usually no building work is taking place. It is expected that the transmission of data upload messages will not occur more frequently than once a week. The characteristic vectors stored locally in the sensor units 40 are characteristic vectors such as are not considered as a critical event after the classification. These can however still be used to improve the accuracy of the classification.

The above-mentioned four different message types preferably contain a 2-byte checksum in order to enable transmission errors to be determined

Since the sensor units 40 use the same medium, the pipeline, for communication, coordination of access to the data transmission channel is required. If the power consumption for the receipt of data is not critical, random access methods can be employed. Otherwise the receive unit of a sensor unit must be in a passive energy-saving state as often as possible, but without missing messages directed to it. In the case of the inventive pipeline system the following three communication methods have been shown to be suitable:

1. CSMA-CA (Carrier Sense Multiple Access with Collision Avoidance):

The fact that messages are only transmitted by the sensor units if a critical event is present means that the data traffic is normally low. Since the receive unit of the sensor unit only consumes little energy, a random access method is the access mechanism best suited because of its short latency times. In order to avoid message collisions, the sensor units listen in to the data transmission channel for a time when they wish to transmit a message. The message transmission is only started when the data transmission channel is not occupied. Any collisions which might occur can be avoided by an RTS/CTS (Request To Send, Clear to Send) handshake in which the sender initially transmits a message and the receiver answers with a CTS message if it has received the RTS message. Only thereafter is the actual message to be transmitted sent.

2. TDMA (Time Division Multiple Access):

Access to the data transmission channel is granted within time slots which are allocated to specific connections, i.e. pairs of communication devices. The time slots are selected such that alarm messages can be transmitted as quickly as possible. If for example sensor units are disposed along the pipeline every 500 m, up to 60 sensors are provided per pipeline segment, which covers 30 km. With a usual transmission coverage of 5 km a sensor unit has contact with around 20 adjacent sensor units. A specific sensor maintains a communication connection with approximately six of the sensor units. This requires 360 time slots for all communication connections without spatial reviews of time slots. For a time slot length of 1 s, 6 minutes are needed to transmit an alarm to an access point. A time slot length of 1 s is sufficient in this case to transmit 100 bytes. An advantage of TDMA lies in the fact that this method is deterministic. By comparison with CSMA/CA however the latency times are higher.

3. Low Power Listening:

In this method each sensor unit activates its receive unit at regular intervals for a short time and checks whether there are transmissions present. If there are no message transmissions or the sensor unit involved is neither a receiver nor a forwarder of a received message, the receive unit is deactivated again. If a message transmission is present, the sensor unit remains active and receives the message before the sensor unit once again goes into an idle state. A sending communication device repeats the transmission of a message long enough for a receiving communication device to be in a position to hear and to receive the message.

Each transmission, with the exception of broadcast messages, is preferably confirmed in such cases by the receiving sensor unit to the sending communication devices. Such a confirmation message comprises the identifier of the receiving sensor unit and an indicator of the received message, such as type and sequence number for example.

The physical layer identified in FIG. 2 with reference number 73 receives the signal to be transmitted from the signal processor 44 and the downstream digital-analog converter 46. The signal is interpolated by the reconstruction filter 48. Subsequently it is amplified by the amplifier 50. This signal thus amplified is transmitted via the pipeline 10 to each adjacent communication device 30 or to the central processing unit 33. The use of the pipeline 10 as communication channel corresponds to an asymmetrical single line with ground return.

A transmit unit which is grounded by a respective ground rod allows the transmission of a data signal on the pipeline, via which this signal is propagated to the other communication devices. The frequency-dependent attenuation of the signal via the pipeline increases greatly for frequencies above 3 kHz. The overall attenuation depends on the moisture and thus the conductivity of the surrounding ground. The attenuation rises in such cases as the moisture increases. The reason for this lies in a rise in a shunt conductance value which results from the soil with higher moisture. The overall attenuation of the pipeline up to 3 kHz is approximately 1 dB/km for high moisture. An estimation of the sensitivity of the receive part of the physical layer and the coverage of two adjacent access points is as follows: the thermal noise within the considered 3 kHz bandwidth amounts to −140 dBm at 20° C. At lower temperatures below the surface of the ground this value is slightly smaller.

The receive part of a communication device includes a low-noise amplifier (LNA) 51 at its input and a downstream analog-digital converter 49, which together usually add 15 dB of noise power. An appropriate distance to this noise power is 15 dB, in order to provide a suitable probability for a correct detection of a message. For this reason a limit is produced for the detection power of a receive signal at −110 dBm. It is assumed that the signal amplitude of a sent signal amounts to 2 V, which lies in the range of a protection system. This results in the power of −10 dBm at 50Ω line impedance. This leads as a result to a coverage of around 5 km.

The aforementioned observations take account of thermal and methodical noise sources of the receiver. It is also expedient to take account of additional artificial sources. Ground currents in particular generate further receive signals, examples of said signals are harmonic and burst signals from power supplies of train lines not only in rural areas but also within cities.

For this reason robust and simple modulations, such as pulse modulation schemes for example, are proposed. Pulse Width Modulation (PWM), Pulse Location modulation (PLM, also called Pulse Phase Modulation PPM) and Pulse Frequency Modulation (PFM) are simple to implement, both in the receive part and also in the transmit part. These are robust in relation to amplitude deviations since only the widths, phase or repetition frequency of the pulse contain information. A disadvantage of pulse width and pulse frequency modulation is the dependence on the average power of a signal information content, which changes the average power consumption.

Pulse phase modulation does not exhibit this disadvantage. The average signal path and also the power consumption is dependent on the content of the signal information. For a 1-bit encoding the maximum pulse width is half the pulse sequence. For the available bandwidth of 3 kHz a maximum bit rate of 1.5 Kb/s can be derived. In order to provide tolerances for synchronization, the pitch rate should not exceed 1 Kb/s which corresponds to approximately 8 ms per byte. Each message to be transmitted should include a start frame and end frame separation byte sequence, usually 2 bytes.

FIG. 4 shows a schematic diagram of the energy supply unit 42 of a sensor unit 40. The energy is supplied from the already mentioned active corrosion protection system. The voltage drop between the pipeline and a respective ground rod and the available current at the injection (cf. the element of the cathode protection system identified by reference number 20 in FIG. 1) is heavily dependent on the state of the pipeline. The supply of energy to the sensor units must therefore take account of tolerances. In particular current peaks should be avoided in order not to reduce the functionality of the cathode protection system.

Typically a cathode protection system provides a voltage of approximately −2 V. The anode of the power supply is formed by the ground rod made of stainless steel.

Energy consumption is discussed below. The microcontroller of a respective sensor unit must be operated continuously in order to safeguard the signal processing and the system control. Its power consumption of approximately 10 mW at 3.3 V is ensured by a step-up switched voltage regulator, e.g. LTC3459) which can process an input voltage of between 1.5 V and 7 V. The voltage regulator is identified in FIG. 4 with the reference number 70.

In order to reduce the average power consumption of the sensor unit, not only components with low power consumption are used but also components which do not have to be operated continuously. One measure consists of putting the sensor 41 and its amplifier into an idle state as often as this is possible. It is sufficient for the sensor 41 to have a switch-on time of 30 μs at a sampling rate of 10 ms. This requires a switch-on time of the active components, such as its operational amplifier for example, in the range of microseconds or less. Examples of components which meet this requirement are OPA847 or OPA687 from Texas Instruments, which have a switch-on time of 60 ns and a switch-off time of 200 ns, and MAX9914 from MAXIM, which has a switch-on time of 2 μs.

The power requirements of the physical layer are mainly caused by the output power amplifier. It is assumed that the pipeline has an impedance of approximately 50Ω. This requires an output power of 80 mW, in order to safeguard the above-mentioned coverage of 5 km of the communication system. The message length of the communication system amounts to approximately 128 bytes. A transmission time of a byte amounts to 8 ms, so that the transmission of a message lasts approximately 1 s. Taking into account additional protocol information, this leads in the most unfavorable case to a total time of 2 s. This requires an energy of 0.16 Ws for the transmission of a message.

In order to avoid peak currents on the pipeline, an energy store 72 is also provided, for example in the form of a dual-layer capacitor (Gold Cap). During the transmission the amplifier of the sensor 41 and the voltage regulator 71 assigned to the sensor should be switched off by the microcontroller in order to obtain the power from the energy store and not introduce a current into the pipeline.

The use of the cathode protection system for supplying energy to autonomous sensor units allows the monitoring system to be provided with a significantly lower effort needed to obtain the energy by comparison with the prior art systems. The use of the cathode protection system as an energy source requires that the monitoring does not use too much energy. This requirement is met by the use of the pipeline for the communication and the use of a modulation scheme with lower complexity. This not only enables the power consumption to be reduced, but also the costs. A further energy reduction is produced by the signal processing being carried out by the sensor units themselves, wherein an optimized multiscalar FFT method is employed. This reduces the complexity of the calculations and thus reduces costs and the power consumption. A detection and classification downstream of the signal processing is likewise undertaken by the sensor units themselves. This enables the necessary communication to be reduced to a minimum. This ensures a low power consumption as well as small latency times in the event of alarm messages to be transmitted. A database with reference characteristic vectors necessary for the classification can be created off-line and transmitted to the sensor units. This enables the classification performance to be increased, whereby the number of incorrect alarm messages reduces over time. This also enables the energy requirement to be reduced.

1-16. (canceled)

17. A pipeline system, comprising
at least one electrically-conducting pipeline, which is connected to the ground and which is isolated from the ground;
a cathode protection system, which comprises a plurality of ground rods arranged in the ground, which are each connected electrically to the ground and are coupled electrically to the pipeline;
a communication system with a plurality of communication devices, allowing data to be transmitted via the pipeline for communication between the communication devices;
wherein the communication devices comprise sensor units arranged along the pipeline, which are supplied with energy from the cathode protection system.

18. The pipeline system as claimed in claim 17, wherein the sensor units are seismic sensor units for detecting ground tremors.

19. The pipeline system as claimed in claim 17, wherein the communication devices are supplied with energy from the cathode protection system.

20. The pipeline system as claimed in claim 17, wherein an energy supply unit of a respective sensor unit is connected electrically between an assigned ground rod of the cathode protection system and the pipeline, especially a bracket of the cathode protection system surrounding the pipeline, wherein energy is able to be obtained by the energy supply unit for supplying the sensor unit from a voltage difference between the ground rod and the pipeline.

21. The pipeline system as claimed in claim 20, wherein the energy supply unit is an energy store for temporary energy supply of the sensor unit, especially during the transmission of a message to a communication device, wherein the energy store is able to be charged from the cathode protection system.

22. The pipeline system as claimed in claim 17, wherein a respective sensor unit includes a processing unit for signal processing of a signal resulting from a ground tremor, in which characteristic vectors are determined from the signal and are classified on the basis of a comparison with reference data stored in the sensor unit, wherein, for a classification as a principle event, an alarm message is transmitted by the sensor unit.

23. The pipeline system as claimed in claim 22, wherein the processing unit is embodied to sample the signal of the sensor unit at a sampling rate of 100 Hz.

24. The pipeline system as claimed in claim 22, wherein for determination of the characteristic features by the processing unit, a Fourier transformation is applied to at least one sample vector of the sampled signal with a given plurality of samples per sample window, especially with different sample window sizes.

25. The pipeline system as claimed in claim 22, wherein for determination of the characteristic features by the processing unit a wavelet transformation is able to be applied to the sampled signal.

26. The pipeline system as claimed in claim 24, wherein the resulting, normalized Fourier or wavelet coefficients are able to be compared by the processing unit with reference coefficients stored in the sensor unit.

27. The pipeline system as claimed in claim 17, wherein a sensor of the sensor unit is embodied to detect frequencies of maximum 10 Hz.

28. The pipeline system as claimed in claim 17, wherein a sensor unit comprises a plurality of sensors arranged spatially separated, the signals of which are able to be fed to a common processing unit.

29. The pipeline system as claimed in claim 17, wherein the sensor units are disposed at predetermined distances between two access points of the communication system, wherein a message transmitted from a sensor unit to an access point is transmitted via the intervening sensor units, wherein the message is forwarded by at least some of the intervening sensor units.

30. The pipeline system as claimed in claim 29, wherein the access point is arranged in the pumping and/or valve stations of the pipeline and supplied with energy by an energy supply of the pumping and/or valve station.

31. The pipeline system as claimed in claim 29, wherein the communication devices each comprise a transceiver unit, which is embodied to use a pulse width, pulse phase or pulse frequency modulation or FSK for communication.

32. The pipeline system as claimed in claim 31, the transceiver unit is embodied for communication using CSMA-CA or TDMA or Low Power Listening.

33. A method for operating a pipeline system, wherein the pipeline system comprises:
at least one electrically-conducting pipeline, which is connected to the ground and which is isolated from the ground;
a cathode protection system, comprising a plurality of ground rods arranged in the ground, which are connected electrically to the ground in each case and are coupled electrically to the pipeline;
a communication system with a plurality of communication devices, wherein data is able to be transmitted via the pipeline for communication between the communication devices;
the method comprising:
detecting signals by the communication devices arranged along the pipeline and embodied as sensor units, wherein the sensor units are supplied with energy from the cathode protection system.
